(19) United States
(12) Patent Application Publication
(10) Pub. No.: US 2007/0139575 A1
(43) Pub. Date: Jun. 21, 2007

(54) Display module for LCD

(75) Inventor: Robert Wang, Taoyuan (TW)

Correspondence Address: TROXELL LAW OFFICE PLLC;SUITE 1404, 5205 LEESBURG PIKE, FALLS CHURCH, VA, 22041, US

(73) Assignee: Ceramate Technical Co., Ltd.

(21) Appl. No.: 11/304,742

(22) Filed: Dec. 16, 2005

(51) Int. Cl. G02F 1/1333

(52) U.S. Cl. 349/58

(57) ABSTRACT

A display module for LCD includes a front frame, a plastic frame, a liquid-crystal display (LCD), a brightness enhancing film, a diffusion sheet, a light guide plate and a PCB. The front frame has plural short pins. The plastic frame has plural fixing bars. The LCD, the brightness enhancing film(s), the diffusion sheet, the light guide plate and the PCB are then assembled in the plastic frame orderly. The PCB has plural fixing holes for fitting with the fixing bars of the plastic frame and plugging holes for the short pins to insert through to be welded on the PCB. The front surface of the PCB has a brightness enhancing coating, provided with plural LEDs. The rear surface of the PCB is set with various electronic components. So the display module for LCD can be made by a simple process.

### BACKGROUND OF THE INVENTION

1. Field of the invention

This invention relates to a display module for liquid-crystal display (LCD), particularly to one that is shaped thinner and able to be manufactured by a simple process for reducing cost.

2. Description of the Prior Art

A common conventional display module for LCD, as shown in FIG. 1, is composed of a backlight module 10, an LCD 20 and a current module 30. The backlight module 10 includes a light source, a light guide plate 13 and an optical film. The light source can be a cold cathode fluorescent lamp (C.C.F.L) 11 or LEDs, assembled in a bottom frame 12 or beside a lampshade and providing necessary lights. The light guide plate 13, a light guiding efficiency center of the backlight module 10, is to guide a linear light to become a homogeneous plane light, based on a theory that net points at the bottom of a light guiding acrylic plate is to break down the interference of a light. The optical film, depending on various functions, may include a reflector 14, a diffusion sheet 15 and a brightness enhancing film 16. The reflector 14 is commonly fixed on a plastic frame 17, which is then assembled in the bottom frame 12 behind the light guide plate 13, enabling the non-scattered light to be guided to the light guide plate 13. The diffusion sheet 15 located in front of the light guide plate 13 enables the light to be scattered and diffused evenly. The brightness enhancing film 16 located in front of the diffusion sheet 15 concentrates the light and enhances the brightness. Next, a metallic front frame 18 is to be covered on the bottom frame 12. Then, the LCD 20 can be assembled outside the brightness enhancing film 16. In addition, the circuit module 30, an independent part including a PCB (printed circuit board) for a driving IC, must be combined together. Since the PCB of the circuit module 30 in the conventional display module is independent from the backlight module 10, the conventional LCD becomes rather thick. Therefore, this invention has been devised to keep the circuit module 30 combined with the backlight module properly, achieving a thinner LCD with a reduced manufacturing cost.

### SUMMARY OF THE INVENTION

The prime object of this invention is to offer a display module for LCD.

The main characteristics of the invention are a front frame, a plastic frame, a liquid-crystal display (LCD), a brightness enhancing film at least, a diffusion sheet, a light guide plate and a PCB. The front frame is provided with plural short pins at four corners. The plastic frame extended with plural fixing bars around its circumference is to be confined in the front frame. The LCD, the brightness enhancing film, the diffusion sheet, the light guide plate and the PCB are then assembled in the plastic frame orderly. The PCB is provided with a plurality of fixing holes for fitting with fixing bars of the plastic frame and plugging holes for the short pins of the front frame to penetrate through so as to be welded on the PCB. The front surface of the PCB adjacent to the light guide plate is coated with a brightness enhancing coating for replacing a conventional reflector and provided with a plurality of light emitting diodes (LEDs) arrayed regularly around its circumference. The rear surface of the PCB is set with various electronic components, such as a driving IC, able to keep a display screen controller, a time sequence controller, an AV decoder, a caption display controller and a TV receiving circuit built together in a backlight module. Such an improved structure really enables the manufacturing process simplified and reduces manufacturing cost.

### BRIEF DESCRIPTION OF DRAWINGS

This invention is better understood by referring to the accompanying drawings, wherein:

FIG. 1 is an exploded perspective view of a conventional display module;

FIG. 2 is an exploded side view of a preferred embodiment of a display module for LCD in the present invention;

FIG. 3 is a side view of the preferred embodiment of a display module for LCD in the present invention, showing it assembled;

FIG. 4 is a front perspective view of a PCB in the preferred embodiment of a display module for LCD in the present invention; and

FIG. 5 is a rear perspective view of the PCB in the preferred embodiment of a display module for LCD in the present invention.

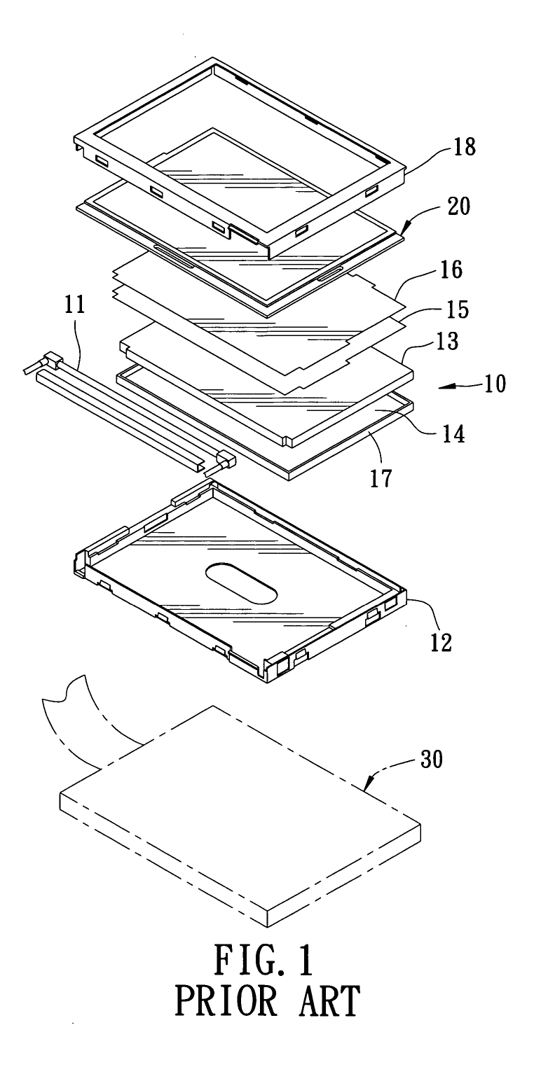

### DETAILED DESCRIPTION OF THE PREFERRED EMBODIMENT

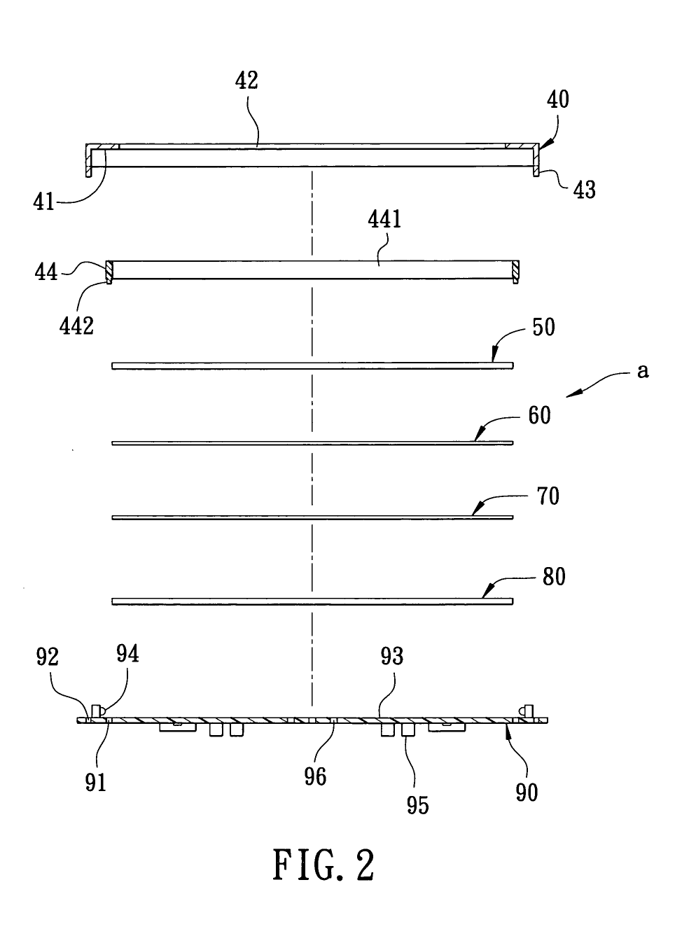

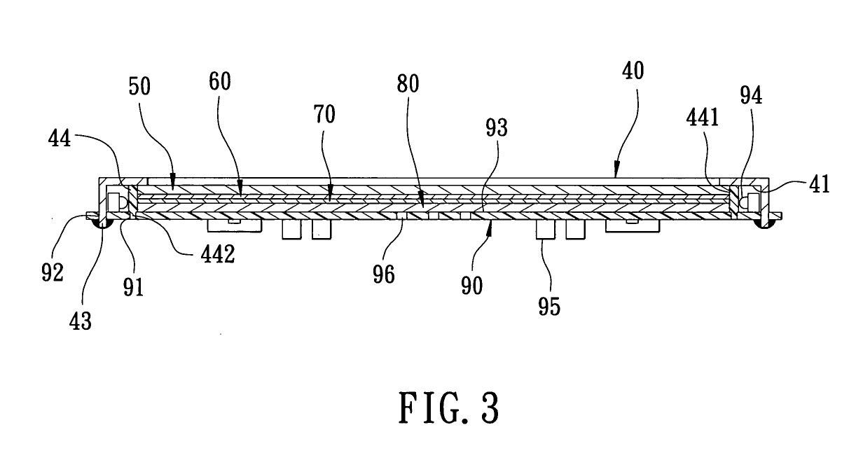

As shown in FIGS. 2 and 3, a preferred embodiment of a display module 1 for LCD in the present invention includes a front frame 40, a plastic frame 44, a liquid-crystal display (LCD) 50, a brightness enhancing film 60 at least, a diffusion sheet 70, a light guide plate 80 and a printed circuit board (PCB) 90.

The front frame 40 made of metal has a chamber 41 at one side, a window 42 in its flat plate portion, and a short pin 43 respectively at four corners.

The plastic frame 44 made of plastic and to be confined in the chamber 41 of the front frame 40 is provided with a restrictive space 441 surrounded by its circumference and a fixing bar 442 respectively extending upright at four corners.

The LCD 50 is fitted restrictively in the restrictive space 441 of the plastic frame 44, absolutely in contact with the bottom of the chamber 41 of the front frame 40, and possible to be seen properly from the window 42.

The brightness enhancing film 60, one at least, is fitted restrictively in the restrictive space 441 of the plastic frame 44, resting on the back of the LCD 50.

The diffusion sheet 70 fitted restrictively in the restrictive space 441 of the plastic frame 44 is resting on the back of the brightness enhancing film 60.

The light guide plate 80 fitted restrictively in the restrictive space 441 of the plastic frame 44 is resting on the back of the diffusion sheet 70.

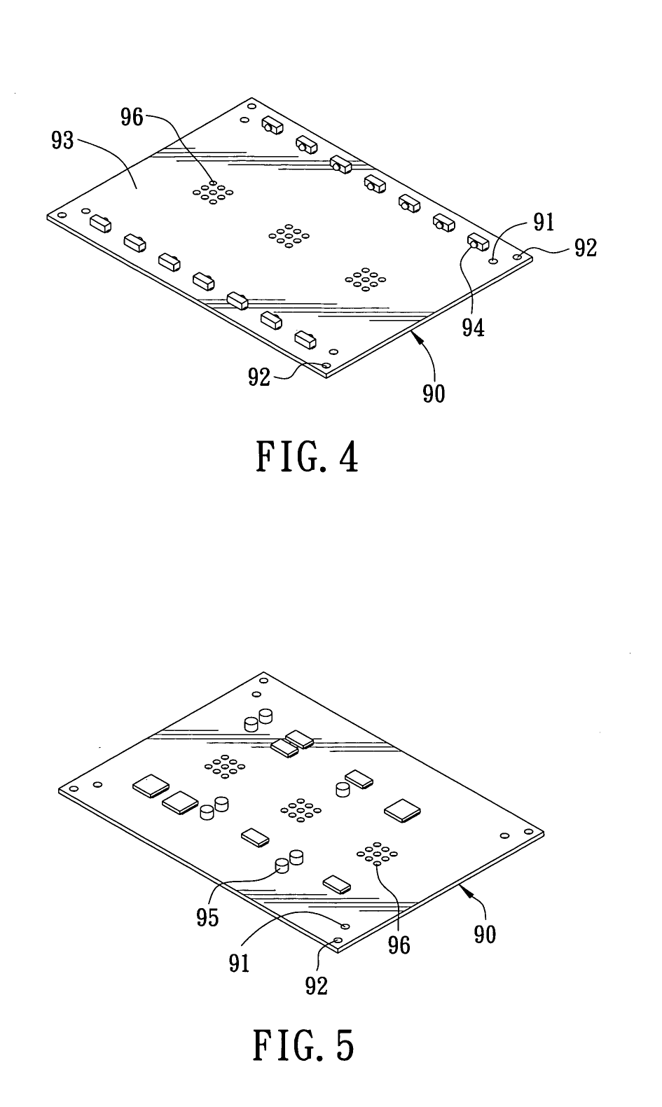

The PCB 90, as shown in FIGS. 4 and 5, is bored with a fixing hole 91 and a plugging hole 92 located more outwards than the fixing hole 91, respectively near the four corners. Each fixing hole 92 is to be fitted with each fixing bar 442 of the plastic frame 44 so as to fix up the plastic frame 44 and the components on it. Each plugging hole 92 is to be inserted through by each short pin 43, which is to be welded properly on the rear side of the PCB 90, enabling the PCB 90 to be assembled fixedly at the back of the light guide plate 80. The front surface of the PCB 90 adjacent to the light guide plate 80 is coated with a brightness enhancing coating 93, used to replace a conventional reflector, enabling non-scattered lights to be transmitted into the light guide plate 80, and provided regularly with a plurality of light emitting diodes (LEDs) 94 spaced apart properly at its two longitudinal or latitudinal sides or both, providing necessary lights. The rear surface of the PCB 90 is set with various electronic components, such as a driving IC, enabling a display screen controller, a time sequence controller, an AV decoder, a caption display controller and a TV receiving circuit to be built together in a backlight module. In addition, plural heat scattering holes 96 are bored at some suitable unused area for dissipating heat during operation of the display module 1.

In assembling, the display module 1 in the present invention is assembled in a process, contrary to that of the conventional one, starting from the front component to the rear one. That is, the plastic frame 44 is first fitted in the chamber 41 of the front frame 40. Next, fix the LCD 50 restrictively within the plastic frame 44 so that the LCD 50 is to rest on the rear side of the front frame 40. Then, continue to attach the brightness enhancing film(s) 60, the diffusion sheet 70, the light guide plate 80 and the PCB 90 orderly with one another. Tjen, each fixing hole 91 is inserted by each fixing bar 442 of the plastic frame 44 and each plugging hole 92 is inserted through by each short pin 43 of the front frame 40 fixedly and correspondingly. Next, keep the portion of each short pin 43 extending out of each plugging hole 92 of the PCB 90 and welded on the PCB, enabling the PCB 90 to be fixed stably with the front frame 40. Consequently, the plastic frame 44, the LCD 50, the brightness enhancing film(s) 60, the diffusion sheet 70 and the light guide plate 80 are restrictively sandwiched between the front frame 40 and the PCB 90 in a close and fixed condition, with an easy, quick and stable assembly. Moreover, with the display screen controller, the time sequence controller, the AV decoder, the caption display controller and the TV receiving circuit built together in the backlight module and without the conventional reflector, the display module 1 can be shaped thinner and manufactured by a simpler process, achieving an attractive improved product with a reduced manufacturing cost.

While the preferred embodiment of the invention has been described above, it will be recognized and understood that various modifications may be made therein and the appended claims are intended to cover all such modifications that may fall within the spirit and scope of the invention.

What is claimed is:

1. A display module for LCD at least comprising:
a front frame possessing a chamber and a short pin at four corners;
a plastic frame fitted in said chamber of said front frame and having plural fixing bars at preset positions of a circumference;
an LCD restrictively assembled within said plastic frame and resting on a rear side of said front frame;
at least a brightness enhancing film restrictively assembled within said plastic frame and resting on a rear side of said LCD;
a diffusion sheet restrictively assembled within said plastic frame and resting on a rear side of said brightness enhancing film;
a light guide plate restrictively assembled within said plastic frame and resting on a rear side of said diffusion sheet;
a PCB provided with a plurality of fixing holes and plugging holes respectively around its circumference at preset positions, each of said fixing holes inserted by each of said fixing bars of said plastic frame correspondingly, each said plugging hole to be inserted through by each said short pin correspondingly, the portion of each said short pin extended out of each plugging hole of said PCB and welded on said PCB to make said PCB resting on a rear side of said light guide plate, the front surface of said PCB adjacent to said light guide plate coated with a brightness enhancing coating for replacing a conventional reflector and guiding non-scattered light into said light guide plate, said PCB provided with a plurality of LEDs arrayed regularly around its circumference for providing necessary lights, a rear surface of said PCB set with various electronic components such as a driving IC, to save a conventional reflector and keep a display screen controller, a time sequence controller, an AV decoder, a caption display controller and a TV receiving circuit built together in a backlight module.

2. The display module for LCD as claimed in claim 1, wherein said PCB is provided with plural LEDs arranged spaced apart properly at two longitudinal sides.

3. display module for LCD as claimed in claim 1, wherein said PCB is provided with plural LEDs arranged spaced apart properly at two latitudinal sides.

4. The display module for LCD as claimed in claim 1, wherein said PCB is provided with plural LEDs arranged spaced apart properly at two longitudinal and two latitudinal sides.

5. The display module for LCD as claimed in claim 1, wherein said PCB is provided with plural heat scattering holes at its preset idle area for releasing heat.

6. The display module for LCD as claimed in claim 1, wherein the portion of each piercing projection extended out of each plugging hole of said PCB is to be welded fixedly on the rear surface of said PCB.

7. The display module for LCD as claimed in claim 1, wherein said piercing projections of said front frame and said plugging holes of said PCB are set at their four corners respectively and correspondently.

8. The display module for LCD as claimed in claim 1, wherein said fixing holes of said plastic frame and said fixing holes of said PCB are set at their four corners respectively and correspondently.
